(19) United States
(12) Patent Application Publication
(10) Pub. No.: US 2021/0105063 A1
(43) Pub. Date: Apr. 8, 2021

(54) LOCATION-BASED WIRELESS COMMUNICATION ACCESS OVER A SATELLITE COMMUNICATION NETWORK

(71) Applicant: Agency for Science, Technology and Research, Singapore (SG)

(72) Inventors: Tung Chong David Wong, Singapore (SG); Xiaoming Peng, Singapore (SG)

(21) Appl. No.: 16/956,421

(22) PCT Filed: Dec. 19, 2018
(86) PCT No.: PCT/SG2018/050623

§ 371 Date: Jun. 19, 2020

(30) Foreign Application Priority Data
Dec. 22, 2017 (SG) 10201710743Q

(51) Int. Cl. H04B 7/185; G01S 5/00; H04W 64/00; H04W 80/02; H04W 72/04

(52) U.S. Cl. CPC H04B 7/1855; H04B 7/18539; G01S 5/0027; H04W 72/042; H04W 80/02; H04W 72/0446; H04W 64/006

(57) ABSTRACT

A number of Satellite VDES MAC protocols are provided. The Satellite VDES MAC protocol provides a significant improvement in the overall throughput in the satellite communication system. In one aspect, a method, a computer readable medium, and an apparatus for wireless communication are provided. The apparatus may determine a geographical location of a terrestrial vessel. The apparatus may determine a subset of time slots in a frame of an uplink communication channel based on the geographical location. The apparatus may select at least one candidate time slot from the subset of time slots. The apparatus may transmit a message using the at least one candidate time slot.

### CROSS-REFERENCE TO RELATED APPLICATION(S)

This application claims the benefit of Singapore Patent Application No. 10201710743Q, entitled “GNSS-BASED WIRELESS COMMUNICATION ACCESS OVER A SATELLITE COMMUNICATION NETWORK” and filed on Dec. 22, 2017, which is expressly incorporated by reference herein in its entirety.

### TECHNICAL FIELD

Various aspects of this disclosure generally relate to multiple wireless communication access over a satellite communication network, and more particularly, to a medium access control (MAC) protocol over a satellite very high frequency (VHF) data exchange system (VDES).

### BACKGROUND

VHF Data Exchange System (VDES) is a digital data exchange system envisaged to offer a globally interoperable and commonly available maritime data communication capability for ship-to-ship and ship-shore safety of navigation communications including an option for global coverage via a satellite component. VDES was originally developed to address emerging indications of overload of VHF Data Link (VDL) of Automatic Identification System (AIS) and simultaneously enabling a wider seamless data exchange for e-navigation, with the intent to support the modernization of Global Maritime Distress and Safety System (GMDSS). Due to the increasing demand on radio spectrum for digital communication such as mobile phone and data, the International Telecommunication Union (ITU) requests more efficient and effective use of radio spectrum, there is a need to provide higher data rates than those used for AIS. This is a key difference between AIS and VDES. Furthermore, there is further need for VDES network protocol to be optimized for data communication so that each VDES message is transmitted with a very high confidence of reception.

The shipborne AIS, as defined by the ITU in Rec. TTU-R M.1371-5, is a ship-to-ship and ship-shore reporting system primarily designed for the purposes of collision avoidance between ships at sea as well as for shore-based traffic monitoring. Two carrier frequencies in the Very High Frequency (VHF) maritime mobile band were allocated for AIS, 161.975 MHz and 162.025 MHz, each having a channel bandwidth of 25 KHz.

The transmission data rate is 9600 bps, using Gaussian Minimum Shift Keying (GMSK) as the modulation method. Accessing to either channels by each ship vessel is accomplished through a technique known as Self-Organization Time Division Multiple Access (SOTDMA), which is a variant of the conventional Time Division Multiple Access (TDMA) technique but without having a central controller to coordinate the multiple access to the channel. For each VHF channel, the SOTDMA frame length is 1 minute in duration and each frame consists of 2250 time slots from which the AIS messages will be transmitted. Unlike in conventional TDMA whereby a central controller assigns the time slots to users, in SOTDMA, time slots are reserved by the users themselves. In essence, whenever a message is sent from a vessel, the transmitter also announces the next intended time slot that it will be transmitting. This information is contained within the message sent. AIS receivers from other vessels within the range of radio visibility (typically about 20 nautical miles) will decode this message and know in advance which time slot has been reserved and hence will avoid transmitting their messages in the reserved time slot. Thus, message collisions are largely mitigated within this area of reception, although there is still a very small probability of message collisions. Furthermore, Carrier Sensing TDMA (CSTDMA) is also defined for another type of AIS station (typically called Class B and used for vessels less than 300 tonnes) and permits development of a low cost transceiver that is fully interoperable with SOTDMA transmissions whilst ensuring priority is always given to SOTDMA transmissions.

The concept of a satellite-based AIS presents a viable solution to provide a global maritime surveillance capability required for long range applications on any given areas on the Earth surface. In a typical scenario of a satellite-based AIS, a low earth orbit (LEO) satellite will detect and decode AIS messages transmitted by vessels within its field of view (FoV). However, the fact that the AIS was not originally developed with space detection in mind presents a host of problems and challenges for a satellite-based AIS. A LEO satellite typically orbits around the Earth at an altitude ranging from 600 km to 1000 km. This corresponds to a FoV of 2880 nm to 3600 nm from horizon to horizon, resulting in coverage of a large number of organized cells within the FoV. As far as the satellite receiver is concerned, it may receive multiple messages transmitted from different organized cells (e.g., SOTDMA cells) in the same time slot, and hence message collisions may occur and cause performance degradation. Conventional receiver designs for satellite-based AIS signal detection that is based on the interference cancellation approach demonstrated that the receiver has an improved performance in terms of enhanced sensitivity to the noise floor, excellent resilience to interference. However, there is a significant increase in the receiver complexity.

Due to traffic congestion in AIS, VDES has been proposed for the next generation of marine safety and navigation-related communication system. This traffic congestion is caused by the increasing number of vessels in the world and limited channels in AIS. VDES is the solution to alleviate the traffic load in AIS. Slot Carrier-Sense TDMA (SCTDMA) is defined to be used for satellite-based uplink transmission for VDES. VDES stations using SCTDMA will detect if the slot is used before transmission and will not transmit on any time slot which has been detected as “occupied”. However, due to the high probability of collision in the channel, the VDES solution suffers poor throughput performance.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Various embodiments provided in this disclosure relate to a Satellite VDES Medium Access Control (MAC) protocol. Such embodiments of the Satellite VDES MAC protocol provide a significant improvement in the overall throughput in the satellite communication system.

Some embodiments of the disclosure readily find application in the area of satellite transmission by ship vessels and sea ports. Some embodiments of the Satellite VDES MAC can be based on GNSS location information, with the goal to enhance the system throughput for Satellite VDES further, while working cohesively with Terrestrial VDES.

In one aspect of the disclosure, a method, a computer readable medium, and an apparatus for wireless communication are provided. The apparatus may determine a geographical location of a terrestrial vessel. The apparatus may determine a subset of time slots in a frame of an uplink communication channel based on the geographical location. The apparatus may select at least one candidate time slot from the subset of time slots. The apparatus may transmit a message using the at least one candidate time slot.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of location-based wireless communication access over a satellite communication network.

FIG. 2 is a diagram illustrating an example of time slot access range of the Satellite-VDES MAC protocol.

FIG. 3 is a diagram illustrating an example of time slot access range of the Satellite-VDES-Partition MAC protocol.

FIG. 4 is a diagram illustrating an example of the usage of the time slots for the Satellite-VDES-Partition MACs and the Terrestrial-VDES-MACs working side by side in a frame.

FIG. 5 is a chart showing simulation results of different satellite MAC protocols.

FIG. 6 is a flowchart of a method of wireless communication.

FIG. 7 is a conceptual data flow diagram illustrating the data flow between different means/components in an exemplary apparatus.

FIG. 8 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of a wireless communication system will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media may include a random-access memory (RAM), a read-only memory (ROM), an electrically erasable programmable ROM (EEPROM), an optical disk storage, a magnetic disk storage, other magnetic storage devices, combinations of the aforementioned types of computer-readable media, or any other medium that can be used to store computer executable code in the form of instructions or data structures that can be accessed by a computer.

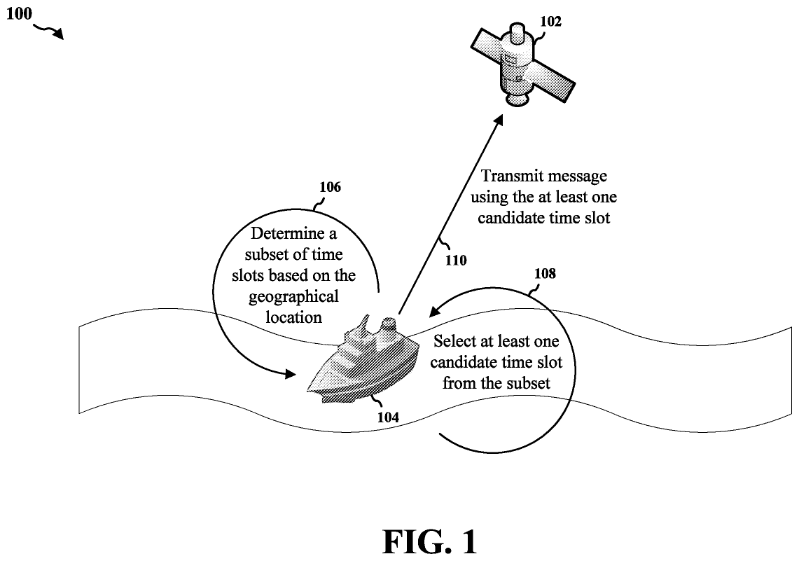

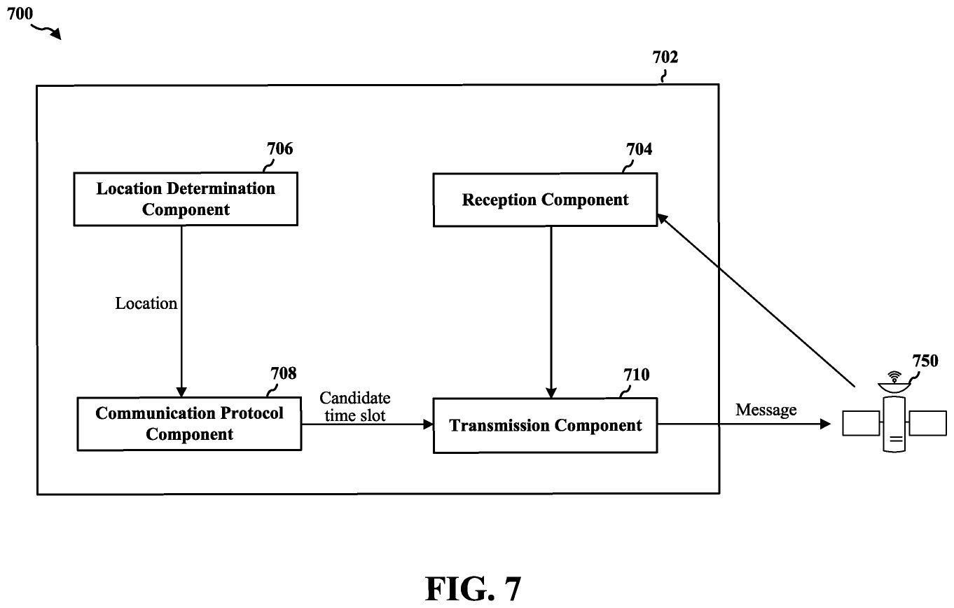

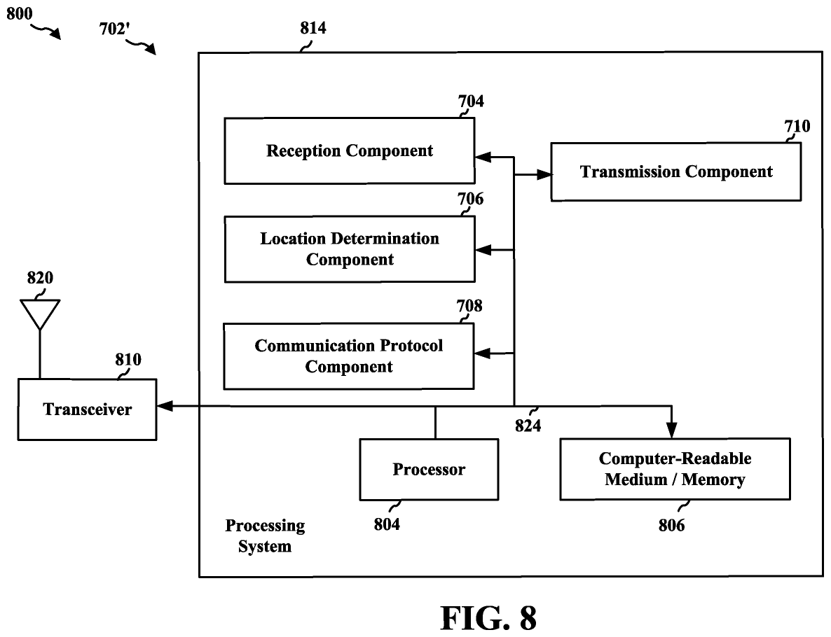

FIG. 1 is a diagram illustrating an example of location-based wireless communication access over a satellite communication network 100. In the example, the satellite communication network 100 may include a satellite 102 and a terrestrial vessel 104. In some embodiments, the terrestrial vessel 104 may be a ship or a fleet of ships. The terrestrial vessel 104 may include an apparatus for wireless communication (e.g., the apparatus 702/702′ described below with reference to FIG. 7/FIG. 8.

At 106, the apparatus may determine a subset of time slots in a frame of an uplink communication channel to the satellite 102 based on the geographical location of the terrestrial vessel 104. In some embodiments, the geographical location of the terrestrial vessel may be determined using a global navigation satellite system (GNSS).

At 108, the apparatus may select at least one candidate time slot from the subset of time slots. At 110, the apparatus may transmit a message to the satellite 102 using the at least one candidate time slot.

In general, terrestrial vessels (such as ships or a fleet of ships) within a geographical region (cluster) may be allocated predefined portions of transmission (uplink) channel in a VHF Data Exchange System. These pre-allocated or assigned time slots in the communication channel may be seen as channel access in a cell corresponding to the geographical region, and these partitioned time slots in the communication channel are “reserved” for these ships or any ship within the geographical region. In some embodiments, the pre-allocated or assigned time slots may correspond to a SOTDMA cell. In some embodiments, the pre-allocated or assigned time slots may correspond to a cell whose size is greater or smaller than the size of a SOTDMA cell. For example, the pre-allocated or assigned time slots may correspond to one or more sub-cells of a SOTDMA cell in more congested ship-shore scenarios via multiple channels.

In one embodiment, the vessels may be enabled to transmit in partitioned time slots in the satellite uplink based on their GNSS location information, so that collisions of messages may be minimized in the satellite uplink and the overall throughput may be enhanced many folds under heavy traffic load. In such embodiment, for each vessel, the Satellite VDES MAC protocol may select only a number of candidate time slots from a number of partitioned time slots according to its GNSS location information, rather than selecting candidate time slots from the full range of the number of time slots (e.g., 2250 time slots) in a frame.

In one embodiment, a communication protocol for uplink communication channel access by a terrestrial vessel to an orbiting vessel (e.g., a satellite) is provided. The protocol may partition a number of time slots from a total number of time slots in a frame of the uplink channel, allocate or assign each partitioned number of time slots to a geographical location of the group of terrestrial vessels, and map the time slots to a geographical position of each terrestrial vessel of the group of terrestrial vessels. In such an embodiment, each partitioned number of time slots may correspond to a SOTDMA cell, and therefore in turn, the geographical location of the group of terrestrial vessels may correspond to the SOTDMA cell. In one embodiment, the geographical location may be determined based on GNSS.

In another embodiment, each sub-partition set of access time slots may be allocated or assigned to a geographical location of the group of terrestrial vessels, and mapped to a geographical position of a terrestrial vessel of the group of terrestrial vessels. In such an embodiment, each partitioned number of time slots may correspond to a SOTDMA cell, and therefore in turn, the geographical location of the group of terrestrial vessels may correspond to an SOTDMA sub-cell.

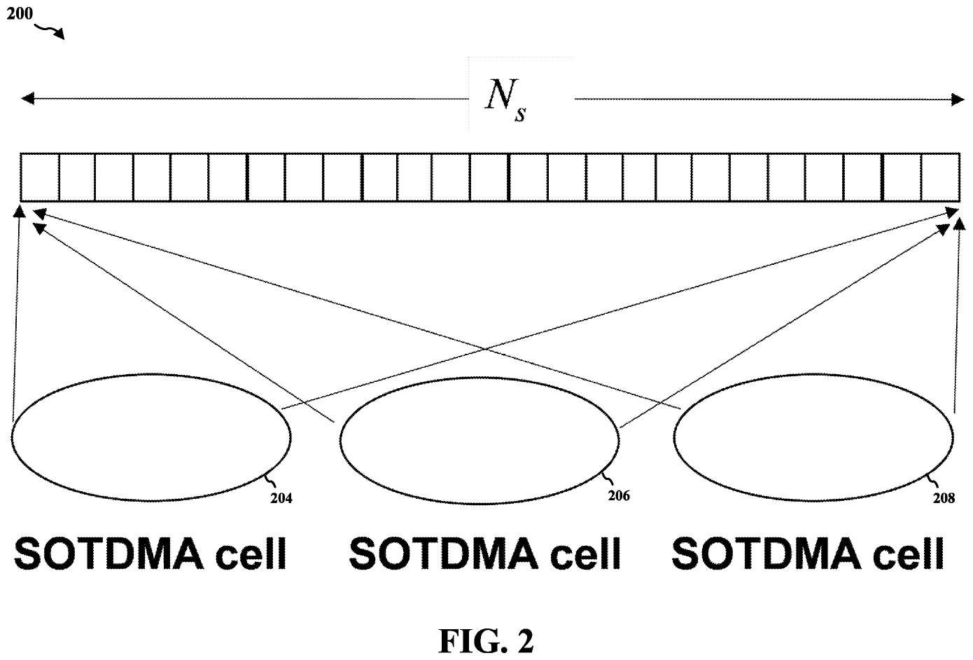

The communication protocol provided in this disclosure may be used by terrestrial vessels (e.g., ships) for maritime communication by satellite link. The Satellite-VDES MAC protocol is modelled like Satellite-AIS MAC protocol. It has the same performance as Satellite-Slotted Aloha protocol under equal channel load conditions in each TDMA frame. FIG. 2 is a diagram 200 illustrating an example of time slot access range of the Satellite-VDES MAC protocol. In the example, each of SOTDMA cells 204, 206, and 208 may access the full range of time slots (e.g., Nₛ time slots) of a frame. In some embodiments, Satellite-VDES MAC protocol may use Slot Carrier-Sense TDMA (SCTDMA) MAC protocol for channel access.

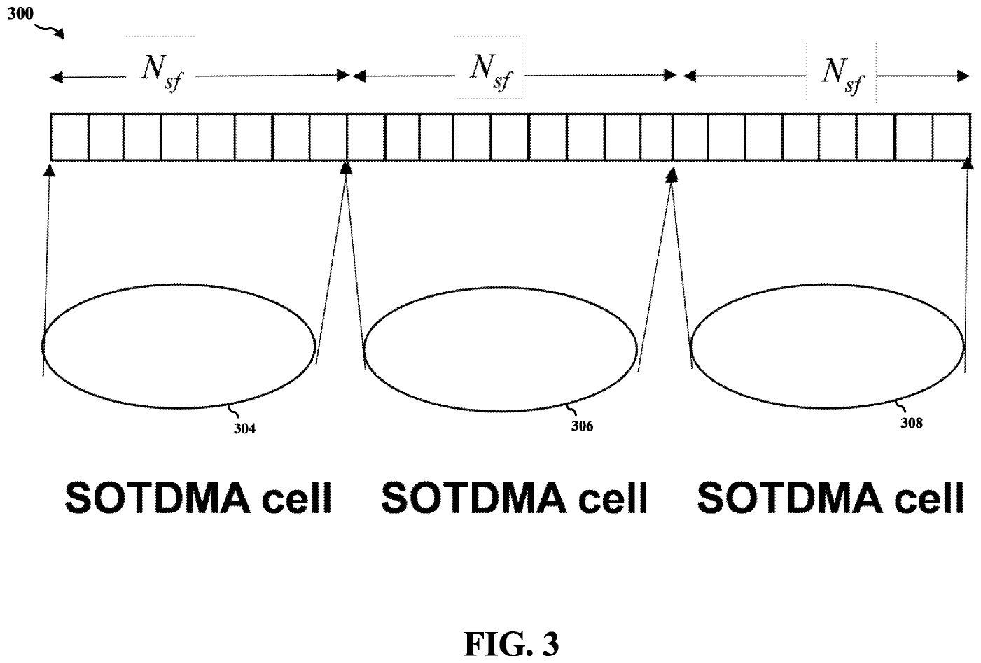

Some embodiments of the disclosure provide a new Satellite VDES MAC protocol, which may be referred to as Satellite-VDES-Partition MAC protocol. FIG. 3 is a diagram 300 illustrating an example of time slot access range of the Satellite-VDES-Partition MAC protocol. As illustrated, in the Satellite-VDES-Partition MAC protocol, each SOTDMA cell (e.g., SOTDMA cell 304, 306, or 308) may only access a portion, N_{sf}, of the total number of time slots, Nₛ, in a frame. Even though three SOTDMA cells 304, 306, 308 are shown in the example, the number of SOTDMA cells may be more than three or less than three. The number of SOTDMA cells, N_{c}, is Nₛ/N_{sf}. The key idea is to reduce collisions in the uplink communication channel by partitioning the time slots in a frame for each SOTDMA cell channel access. In some embodiments, Slot Carrier-Sense TDMA (SCTDMA) may be used by the Satellite-VDES-Partition MAC protocol for channel access. The portion of time slots for vessels in each cluster may be tied to one of the SOTDMA cells as shown in FIG. 3.

In some embodiments, the location information or positions of the vessels may be computed in each of the regions based on GNSS positioning subsystem and the corresponding portion of time slots in each cluster that are non-overlapping with those of other SOTDMA cells. This key idea of non-overlapping usage of the partitioned time slots by the terrestrial vessels based on their positions in the SOTDMA cells cuts down the possibility of message collision in the satellite uplink and therefore enhance the overall satellite throughput in the satellite uplink.

Some embodiments of the disclosure provide another new Satellite VDES MAC protocol, which may be referred to as Satellite-VDES-Partition-2 MAC protocol. Both the Satellite-VDES-Partition MAC and Satellite-VDES-Partition-2 MAC protocols are position-based MAC protocols. In some embodiments, the Satellite-VDES-Partition MAC protocol and the Satellite-VDES-Partition-2 MAC protocol may be interchangeable without changing the essence of the disclosure, but with a difference. The difference between Satellite-VDES-Partition MAC and Satellite-VDES-Partition-2 MAC protocols is that the former uses Slotted Aloha MAC protocol within the partition time slots for channel access via SCTDMA MAC protocol, while Satellite-VDES-Partition-2 MAC protocol uses Satellite-VDES MAC protocol within the partition time slots for channel access via Satellite AIS MAC protocol.

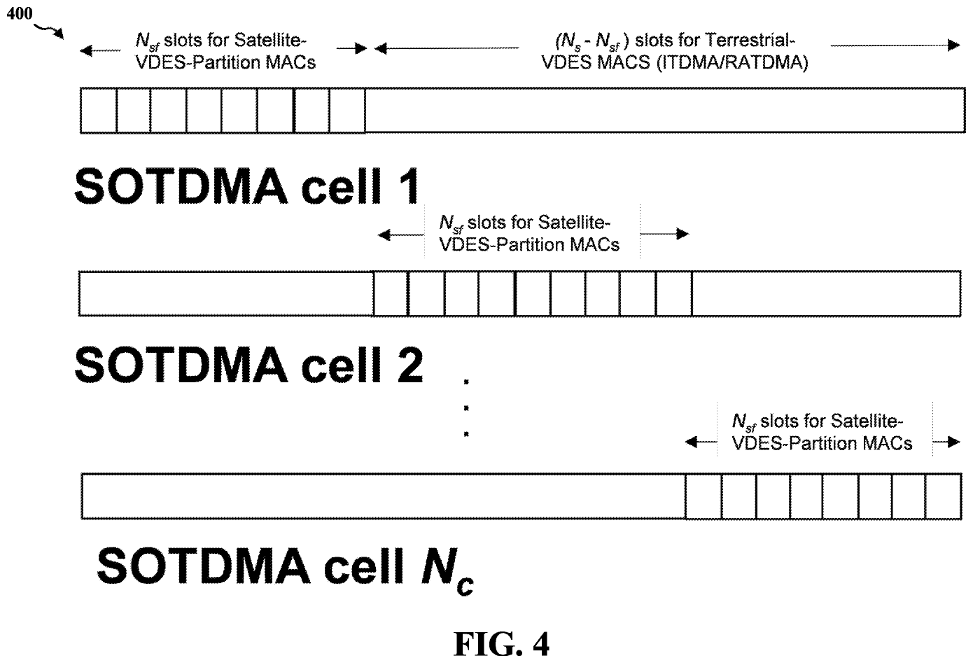

SOTDMA cells may be used as an example to refer to the frame structure with Nₛ=2250. For example, the SOTDMA cells may be arranged in adjacent hexagonal or square cells. FIG. 4 is a diagram 400 illustrating an example of the usage of the time slots for the Satellite-VDES-Partition MACs and the Terrestrial-VDES-MACs working side by side in a frame. In some embodiments, the Terrestrial-VDES-MACs may be incremental time division multiple access (ITDMA) and/or random access time division multiple access (RATDMA). Within each SOTDMA cell, after starting up with RATDMA, ITDMA may be used for subsequent reservation of slots for terrestrial VDES MAC protocol. Terrestrial ITDMA may coexist with Satellite-VDES MAC protocol as well as Satellite-VDES-Partition MAC protocols using additional rules to the existing rules in VDES. The additional rules may be used to exclude the partitioned set of satellite access time slots from the existing terrestrial VDES MAC as well as to accommodate a new set of partition satellite access time slots when moving from one SOTDMA cell region to another SOTDMA cell region according to the GNSS location information. Algorithms for next SOTDMA cell projection may also be developed based on periodic GNSS positioning records.

In the example of FIG.4, in SOTDMA cell 1, the first N_{sf} time slots in a frame may be reserved for Satellite VDES-Partition MACs, while the rest of Nₛ-N_{sf} time slots may be used for Terrestrial-VDES MACs (ITDMA/RATDMA). In SOTDMA cell 2, the second N_{sf} time slots in a frame may be reserved for Satellite VDES-Partition MACs, while the rest of Nₛ-N_{sf} time slots may be used for Terrestrial-VDES MACs (ITDMA/RATDMA). Similarly, in SOTDMA cell N_{c}, the last N_{sf} time slots in a frame may be reserved for Satellite VDES-Partition MACs, while the rest of Nₛ-N_{sf} time slots may be used for Terrestrial-VDES MACs (ITDMA/RATDMA). The number of partition satellite access time slots for each SOTDMA cell may be different. In one embodiment, Nₛ is set to 2250, while N_{sf} is set to 2, and N_{c} is therefore 1125 unless otherwise stated.

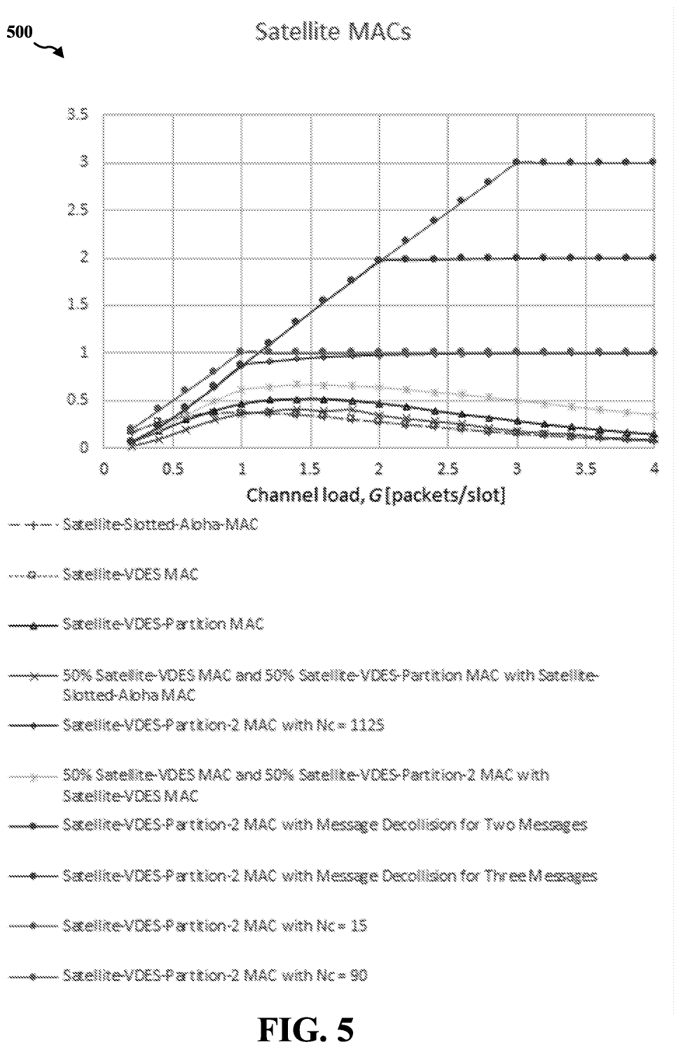

FIG. 5 is a chart 500 showing simulation results of different satellite MAC protocols. As shown, Satellite-VDES-Partition MAC protocol has better normalized throughput than that of Satellite-VDES MAC protocol over the region of 0.65 channel load and above. The simulation result for 50% channel load using Satellite-VDES MAC protocol and 50% channel load using Satellite-VDES-Partition MAC protocol is also shown. Above 1 channel load, its performance is between that of Satellite-VDES MAC protocol and Satellite-VDES-Partition MAC protocol. FIG. 5 shows enhanced normalized throughput for the Satellite-VDES-Partition-2 MAC protocol. The difference between the Satellite-VDES-Partition MAC and the Satellite-VDES-Partition-2 MAC protocols is that the former uses partitioned slots N_{sf} via the Satellite-Slotted-Aloha MAC protocol, while the latter uses partitioned slots Ns_{f} via the Satellite-VDES MAC protocol. The gain in normalized throughput is tremendous. The simulation result for 50% channel load using Satellite-VDES MAC protocol and 50% channel load using Satellite-VDES-Partition-2 MAC protocol is also shown. Its performance is between that of Satellite-VDES MAC and Satellite-VDES-Partition-2 MAC protocols. Coupling Satellite-VDES-Partition-2 MAC protocol with a message decollision method applied to two messages or three messages, the maximum throughput may be doubled or tripled, as shown in FIG. 5. If the message decollision method is applied to more messages, the throughput may be increased further.

From FIG. 5, decreasing the number of clusters from 1125 to 90 or 15 increases the throughput at the lower end of the offered load. The number of clusters of 90 corresponds to an approximate FoV of about 60 degrees from a LEO satellite at 600 km altitude, while 15 clusters corresponds to 30 degrees. Adjustments may be made by rounding off the number of clusters to align to the number of time slots (e.g., 2250) in a frame.

The embodiments of the disclosure may provide enhanced system throughput for Satellite VDES by partitioning time slots in a frame for channel access in the satellite uplink. As the provided solution is based on GNSS positioning which is already available in VDES, there is no need for additional GNSS system integration. Further, the solution offers selection of time slots within a set range of partitioned time slots, rather than within the full range of time slots within a frame, resulting in a less complex operation. In various embodiments, under fully-loaded ship-to-ship transmissions in a SOTDMA frame, a number of partitioned time slots is still guaranteed to be available for ship-to-satellite transmissions. In various embodiments, under medium load ship-to-ship transmissions in a SOTDMA frame, ship-to-satellite transmission collisions may be minimized by having non-overlapping access time slots for vessels among each of the SOTDMA cells.

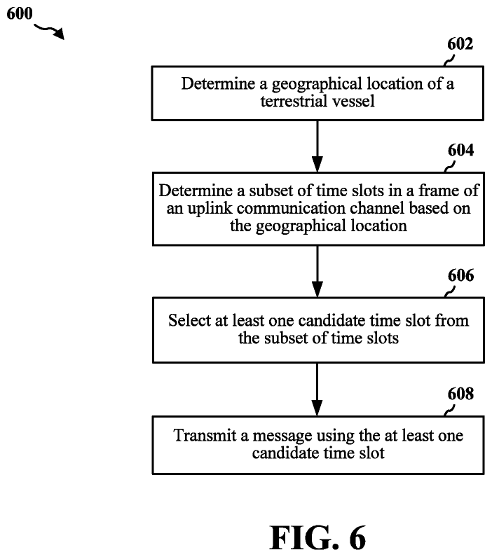

FIG. 6 is a flowchart 600 of a method of wireless communication. The method may be performed by an apparatus (e.g., the apparatus 702/702′ described below with reference to FIG. 7/FIG. 8). In some embodiments, the apparatus may be included in a terrestrial vessel. In some embodiments, the apparatus may perform operations corresponding to the operations described above with reference to FIG. 1. In some embodiments, the apparatus may conduct wireless communication using the Satellite-VDES-Partition MAC protocols described above with reference to FIGS. 3 and 4.

At 602, the apparatus may determine a geographical location of a terrestrial vessel. In some embodiments, the apparatus may be located on the terrestrial vessel. In some embodiments, the geographical location may be determined based on a global navigation satellite system.

At 604, the apparatus may determine a subset of time slots in a frame of an uplink communication channel based on the geographical location. In some embodiments, the uplink communication channel may provide uplink communication channel access by the terrestrial vessel to an orbiting vessel. In some embodiments, the uplink communication channel may be in a VHF Data Exchange System.

In some embodiments, the subset of time slots may be reserved for terrestrial vessels within a geographical region that includes the geographical location. In some embodiments, the subset of time slots may correspond to a Self-Organization Time Division Multiple Access cell or other cell sizes, where the geographical region corresponds to the Self-Organization Time Division Multiple Access cell or other cell sizes. In such embodiments, for the Self-Organization Time Division Multiple Access cell or other cell sizes, time slots outside of the subset of time slots in the frame may be used by one or more Terrestrial VHF Data Exchange System Media Access Control protocols. In some embodiments, time slots in the frame may be divided among a plurality of geographical regions covered by an orbiting vessel. The plurality of geographical regions includes the geographical region. Time slots assigned to different geographical regions may be non-overlapping.

At 606, the apparatus may select at least one candidate time slot from the subset of time slots. In some embodiments, the at least one candidate time slot may be selected based on the geographical location of the terrestrial vessel.

At 608, the apparatus may transmit a message using the at least one candidate time slot. In some embodiments, the message may be transmitted to a satellite.

FIG. 7 is a conceptual data flow diagram 700 illustrating the data flow between different means/components in an exemplary apparatus 702. The apparatus 702 may include one or more computing devices. The apparatus 702 may include a reception component 704 that receives downlink transmission from a satellite 750.

The apparatus 702 may include a transmission component 710 that transmits message to the satellite 750. In one embodiment, the transmission component 710 may perform the operations described above with reference to 110 in FIG. 1 or 608 in FIG. 6. The reception component 704 and the transmission component 710 may collaborate to coordinate the communication of the apparatus 702.

The apparatus 702 may include a location determination component 706 that is configured to determine the location of the apparatus 702. In one embodiment, the location determination component 706 may perform the operations described above with reference to 602 in FIG. 6.

The apparatus 702 may include a communication protocol component 708 that is configured to select at least one candidate time slot for uplink transmission based on the location provided by the location determination component 706. In one embodiment, the communication protocol component 708 may perform the operations described above with reference to 106 or 108 in FIG. 1, or 604 or 606 in FIG. 6. The selected candidate time slot is provided to the transmission component 710 for transmitting uplink messages to the satellite 750.

The apparatus 702 may include additional components that perform each of the blocks of the algorithm in the aforementioned flowchart of FIG. 6. As such, each block in the aforementioned flowchart of FIG. 6 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combinations thereof.

FIG. 8 is a diagram 800 illustrating an example of a hardware implementation for an apparatus 702′ employing a processing system 814. In one embodiment, the apparatus 702′ may be the apparatus 702 described above with reference to FIG. 7. The processing system 814 may be implemented with a bus architecture, represented generally by the bus 824. The bus 824 may include any number of interconnecting buses and bridges depending on the specific application of the processing system 814 and the overall design constraints. The bus 824 links together various circuits including one or more processors and/or hardware components, represented by the processor 804, the components 704, 706, 708, 710, and the computer-readable medium/memory 806. The bus 824 may also link various other circuits such as timing sources, peripherals, voltage regulators, and power management circuits, which are well known in the art, and therefore, will not be described any further.

The processing system 814 may be coupled to a transceiver 810. The transceiver 810 is coupled to one or more antennas 820. The transceiver 810 provides a means for communicating with various other apparatus over a transmission medium. The transceiver 810 receives a signal from the one or more antennas 820, extracts information from the received signal, and provides the extracted information to the processing system 814, specifically the reception component 704. In addition, the transceiver 810 receives information from the processing system 814, specifically the transmission component 710, and based on the received information, generates a signal to be applied to the one or more antennas 820.

The processing system 814 includes a processor 804 coupled to a computer-readable medium/memory 806. The processor 804 is responsible for general processing, including the analyzation of data gathered by the apparatus itself through its own sensors and the execution of software stored on the computer-readable medium/memory 806. The software, when executed by the processor 804, causes the processing system 814 to perform the various functions described supra for any particular apparatus. The computer-readable medium/memory 806 may also be used for storing data that is manipulated by the processor 804 when executing software. The processing system 814 further includes at least one of the components 704, 706, 708, 710. The components may be software components running in the processor 804, resident/stored in the computer readable medium/memory 806, one or more hardware components coupled to the processor 804, or some combination thereof

In the following, various aspects of this disclosure will be illustrated:

Example 1 is a method or apparatus for wireless communication. The apparatus may determine a geographical location of a terrestrial vessel. The apparatus may determine a subset of time slots in a frame of an uplink communication channel based on the geographical location. The apparatus may select at least one candidate time slot from the subset of time slots. The apparatus may transmit a message using the at least one candidate time slot.

In Example 2, the subject matter of Example 1 may optionally include that the uplink communication channel may provide uplink communication channel access by the terrestrial vessel to an orbiting vessel.

In Example 3, the subject matter of any one of Examples 1 to 2 may optionally include that the uplink communication channel may be in a VHF Data Exchange System.

In Example 4, the subject matter of any one of Examples 1 to 3 may optionally include that the subset of time slots may be reserved for terrestrial vessels within a geographical region that includes the geographical location.

In Example 5, the subject matter of Example 4 may optionally include that the subset of time slots may correspond to a Self-Organization Time Division Multiple Access cell or other cell sizes, where the geographical region may correspond to the Self-Organization Time Division Multiple Access cell or other cell sizes.

In Example 6, the subject matter of Example 5 may optionally include that, for the Self-Organization Time Division Multiple Access cell or other cell sizes, time slots outside of the subset of time slots in the frame may be used by one or more Terrestrial VHF Data Exchange System Media Access Control protocols.

In Example 7, the subject matter of any one of Examples 4 to 6 may optionally include that time slots in the frame may be divided among a plurality of geographical regions covered by an orbiting vessel, the plurality of geographical regions including the geographical region, where time slots assigned to different geographical regions are non-overlapping.

In Example 8, the subject matter of any one of Examples 1 to 7 may optionally include that the geographical location may be determined based on a global navigation satellite system.

In Example 9, the subject matter of any one of Examples 1 to 8 may optionally include that the at least one candidate time slot may be selected based on the geographical location.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication, the method comprising:
determining a geographical location of a terrestrial vessel;
determining a subset of time slots in a frame of an uplink communication channel based on the geographical location;
selecting at least one candidate time slot from the subset of time slots; and
transmitting a message using the at least one candidate time slot.

2. The method of claim 1, wherein the uplink communication channel provides uplink communication channel access by the terrestrial vessel to an orbiting vessel.

3. The method of claim 1, wherein the uplink communication channel is in a Very High Frequency Data Exchange System.

4. The method of claim 1, wherein the subset of time slots is reserved for terrestrial vessels within a geographical region that includes the geographical location.

5. The method of claim 4, wherein the subset of time slots corresponds to a Self-Organization Time Division Multiple Access cell, wherein the geographical region corresponds to the Self-Organization Time Division Multiple Access cell.

6. The method of claim 5, wherein, for the Self-Organization Time Division Multiple Access cell, time slots outside of the subset of time slots in the frame are used by one or more Terrestrial Very High Frequency Data Exchange System Media Access Control protocols.

7. The method of claim 4, wherein time slots in the frame are divided among a plurality of geographical regions covered by an orbiting vessel, the plurality of geographical regions including the geographical region, wherein time slots assigned to different geographical regions are non-overlapping.

8. The method of claim 1, wherein the geographical location is determined based on a global navigation satellite system.

9. The method of claim 1, wherein the at least one candidate time slot is selected based on the geographical location.

10. An apparatus for wireless communication, the apparatus comprising:
a memory; and
at least one processor coupled to the memory and configured to:
determine a geographical location of a terrestrial vessel;
determine a subset of time slots in a frame of an uplink communication channel based on the geographical location;
select at least one candidate time slot from the subset of time slots; and
transmit a message using the at least one candidate time slot.

11. The apparatus of claim 10, wherein the uplink communication channel provides uplink communication channel access by the terrestrial vessel to an orbiting vessel.

12. The apparatus of claim 10, wherein the uplink communication channel is in a Very High Frequency Data Exchange System.

13. The apparatus of claim 10, wherein the subset of time slots is reserved for terrestrial vessels within a geographical region that includes the geographical location.

14. The apparatus of claim 13, wherein the subset of time slots corresponds to a Self-Organization Time Division Multiple Access cell, wherein the geographical region corresponds to the Self-Organization Time Division Multiple Access cell.

15. The apparatus of claim 14, wherein, for the Self-Organization Time Division Multiple Access cell, time slots outside of the subset of time slots in the frame are used by one or more Terrestrial Very High Frequency Data Exchange System Media Access Control protocols.

16. The apparatus of claim 13, wherein time slots in the frame are divided among a plurality of geographical regions covered by an orbiting vessel, the plurality of geographical regions including the geographical region, wherein time slots assigned to different geographical regions are non-overlapping.

17. The apparatus of claim 10, wherein the geographical location is determined based on a global navigation satellite system.

18. The apparatus of claim 10, wherein the at least one candidate time slot is selected based on the geographical location.

19. A non-transitory computer-readable medium storing computer executable code, comprising instructions for:
determining a geographical location of a terrestrial vessel;
determining a subset of time slots in a frame of an uplink communication channel based on the geographical location;
selecting at least one candidate time slot from the subset of time slots; and
transmitting a message using the at least one candidate time slot.

20. The non-transitory computer-readable medium of claim 19, wherein the subset of time slots is reserved for terrestrial vessels within a geographical region that includes the geographical location.
